(19) United States
(12) Patent Application Publication
(10) Pub. No.: US 2004/0132608 A1
(43) Pub. Date: Jul. 8, 2004

(54) Multi-purpose refractory material

(76) Inventor: Thomas Joseph Lally, Oak Brook, IL (US)

Correspondence Address: Thomas Joseph Lally, 603 Mallard Lane, Oak Brook, IL, 60523, US

(21) Appl. No.: 10/685,214

(22) Filed: Oct. 14, 2003

Related U.S. Application Data
(63) Continuation-in-part of application No. 10/338,425, filed on Jan. 8, 2003.
Application No. 10/338,425 is a division of application No. 09/602,067, filed on Jun. 22, 2000, now Pat. No. 6,533,821.

(51) Int. Cl. C04B 35/03

(52) U.S. Cl. 501/111; 106/691; 501/123

(57) ABSTRACT

The present invention relates to a multi-purpose refractory material. The present material is moldable and castable and thus ideal for a variety of refractory applications including but not limited to: casting oven parts, panels, blocks, and tiles, bonding parts together, and filing in voids in finished castables. The composition generally comprising potassium phosphate, magnesium oxide and tricalcium phosphate. The present composition is able to withstand very high temperatures while maintaining stability.

### RELATION TO OTHER APPLICATIONS

The present invention is a continuation-in-part of, and claims priority of U.S. patent application Ser. No. 10/338,425 filed in January of 2003 which is a divisional of U.S. patent application Ser. No. 09/602,067, filed Jun. 22, 2000 now U.S. Pat. No. 6,533,821, all of which are incorporated by reference in their entirety.

### FIELD OF INVENTION

The present invention relates to a multi-purpose refractory material. More specifically, the invention relates to a phosphate based refractory material for use in a variety of applications including but not limited to: casting and spraying oven parts, panels, blocks and tiles, bonding parts together, and filing in voids in finished castables. The present invention can also be used as a dental cement suitable for casting impressions and as a refractory mold for teeth, bridges and partials. Finally, the invention can be used as a fireproofing material for structural members of buildings.

### BACKGROUND OF INVENTION

Refractories are heat resistant materials that are used for a variety of high-temperature applications including: linings for furnaces, ovens and other reactors, high-temp panels and blocks, bonding parts together and filling in voids. In addition to being heat resistant (usually above 1000° F.), refractory materials must be able to hold up against physical and chemical corrosion.

Most refractory materials are specialized for specific applications within the refractory industry. For example most refractory compositions are used solely as castables or sprayables, few have the ability to be used as both. The present invention is multi-purpose refractory material that exhibits superior compression strength, increased ease of use, quick turn around time.

### SUMMARY OF INVENTION

An object of the present invention is to provide a multi-purpose refractory and method for producing the same that overcome many of the disadvantages of the prior art.

Another object of the present invention is to provide a multi-purpose refractory. An advantage of the present invention is that it can be used as both as a castable and sprayable.

Yet another object of the present invention is to provide a multi-purpose refractory that provides quick turnaround time. An advantage of the present invention is its fast setting time and rapid strength gain. One embodiment of the present invention has setting time of 90 minutes or less. Another salient feature of the present invention is the refractory's quick demolding time. Yet another advantage of the present invention is its ease of use as only water is needed to activate the dry composition.

Another object of the present invention is to provide a refractory that provides fine detail as a castable. An advantage of the present invention is its superior bonding ability without the use of bonding agents.

Another objection of the present invention is to provide a castable refractory with high compressive strengths. An advantage of the present invention is its high initial compressive strengths. Certain embodiments of the present invention have compressive strengths of ˜3,000 psi at 3 hours, ˜7,500 psi at 3 days, and ˜8,500 psi after 7 days. The present invention's high green strength allows reduction of casting thickness which reduces cost.

Yet another object of the present invention is to provide a refractory material that can be used as a fireproofing material for structural members of buildings. Advantages of the present invention are its superior bonding properties, high compressive strengths, and ability to withstand temperatures in excess of 2,000° F. for prolonged periods of time.

The present invention relates to a multi-purpose refractory material. The present material is moldable and castable and thus ideal for a variety of refractory applications including but not limited to: casting oven parts, panels, blocks and tiles, bonding parts together, and filing in voids in finished castables.

### DETAILED DESCRIPTION OF THE INVENTION

The present invention is a moldable and castable material, thereby making it ideal as a refractory. The refractory formulation is comprised of an alkali metal or alkali earth metal phosphate, a metal oxide (or hydroxide), and tricalcium phosphate, preferably an alkali earth metal phosphate.

Preferred Embodiment

One exemplary refractory formulation is comprised of potassium phosphate, magnesium oxide and tricalcium phosphate. The amount of each component present in the refractory composition can vary but generally fall within the following weight percent ranges:

Potassium phosphate—an acceptable range is between 25-75 weight percent, preferably between 40-65 weight percent.

Magnesium oxide—an acceptable range is between 15-55 weight percent, preferably between 24-45 weight percent.

Tricalcium phosphate—an acceptable range is between 0.5-25 weight percent, preferably between 3-15 weight percent.

The refractory formulation can be adapted to prevent molten metal from sticking to it with the addition of microsilicas. A suitable microsilica is calcium silicate, in particle sizes ranging from approximately 10 microns to 40 microns.

Exemplary formulations of the refractory binder include the following:

| Formulation I* | |
|---|---|
| Potassium phosphate (technical grade-30 microns) | 61 percent |
| Magnesium Oxide (technical grade-30 microns) | 31 percent |
| Tricalcium Phosphate | 8 percent |

*all percentages are percent by weight

Water is added up to 30 weight percent.

The composition of Formulation I can be combined with a filler so that the ultimate mixture contains between 8 and 25 percent weight of the formulation and 75 to 92 percent by weight of the filler. The variation of binder percentage depends on desired consistency and use of the ultimate mixture.

| Formulation II* | |
|---|---|
| Potassium phosphate (technical grade-30 microns) | 61 percent |
| Magnesium Oxide (technical grade-30 microns) | 31 percent |
| Tricalcium Phosphate | 8 percent |

*all percentages are percent by weight

Water is added up to 30 weight percent.

In Formulation II, CaSiO₃ is added to reduce build-up of slag when the binder is used in castable formulations. The silicate addition also reduces build-up in refractories which come in contact with molten metals.

| Formulation III* | |
|---|---|
| Potassium phosphate | 45 percent |
| Magnesium phosphate | 45 percent |
| Tricalcium phosphate | 10 percent |

*all percentages are percent by wieght

Water is added up to 30 weight percent.

Formulation III is suitable for casting refractory oven parts, panels, blocks and tiles. In such applications, the binder is usually present at between 80-90 weight percent, with the remainder being filler.

| Formulation IV* | |
|---|---|
| Potassium phosphate | 41 percent |
| Magnesium oxide | 41 percent |
| Tricalcium phosphate | 4.5 percent |
| Calcium silicate | 4.5 percent |

*all percentages are percent by weight

Water is added up to 30 weight percent.

Formulation IV is a multi-purpose refractory grade ceramic cement which can also be used for bonding formed parts together, filling voids in finished castable, and in vivo repair of fractures.

| Formulation V* | |
|---|---|
| Potassium phosphate | 41 percent |
| Magnesium oxide | 41 percent |
| Tricalcium phosphate | 4.5 percent |
| Silicon dioxide | 4.5 percent |

*all percentages are percent by weight

Water is added up to 30 weight percent.

Formulation V is a dental cement suitable for casting of impression and as a refractory mold for teeth, bridges and partials.

Some of the formulations disclosed herein incorporate fillers. Exemplary fillers include, but are not limited to: mullite, alumina, sand, clay, volcanic glasses, kyanite, bauxite, aluminum oxide, silicon dioxide, chrome oxide, iron oxide, and mixtures thereof.

Aside, from MgO (preferred), a myriad of other oxide and hydroxide powders can be utilized, including but not limited to FeO, Al(OH)₃, FeO₃, Fe₂O₄ and Zr(OH)₄.

Dry Composition Preparation

The materials preparation portion of the bio-adhesive formulations disclosed in the original application (U.S. application Ser. No. 09/602,067 filed Jun. 20, 2000, now U.S. Pat. No. 6,533,821 issued to Lally on Mar. 18, 2003) is incorporated herein in its entirety, components of the refractory mixture can be dry-mixed and homogenized via a myriad of devices.

A metal oxide (or hydroxide) is a salient feature of the present invention. Optionally, the oxide can be calcined. Calcination temperatures and durations are determined empirically, depending on the final characteristics and setting times desired. Generally, however, calcinations temperatures of up to 1300° C. for up to several hours are typical. Generally, pharmaceutical grade oxides (hydroxides) are utilized.

The alkali metal phosphate is preferably mono potassium phosphate.

Slurry Preparation

The material is shipped dry to the ultimate situs of usage and is then applied as a slurry once water is added. The amount of water added depends on the workability desired but can be added up to 30% by weight. The slurry is then mixed by a hand, hand mixer or the mixing device to obtain a homogenized slurry. Mixing times and rates will vary depending on slurry composition, desired consistency and other characteristics. When used as a castable it may be advantageous to vibrate the slurry during setting to remove any air bubbles trapped within the mixture. Generally, and unless additional heat is applied, the exothermic reaction resulting from refractory, with or without the addition of micro-silicates, results in a final green strength of approximately 8500 psi.

Having described the basic concept of the invention, it will be apparent to those skilled in the art that the foregoing detailed disclosure is intended to be presented by way of example only, and is not limiting. Various alterations, improvements, and modifications are intended to be suggested and are within the scope and spirit of the present invention. Additionally, the recited order of the elements or sequences, or the use of numbers, letters or other designations therefore, is not intended to limit the claimed processes to any order except as may be specified in the claims. Accordingly, the invention is limited only by the following claims and equivalents thereto.

All publications and patent documents cited in this application are incorporated by reference in their entirety for all purposes to the same extent as if each individual publication or patent document were so individually denoted.

I claim the following:

1. A refractory comprising:
a. 20-80 wt. % of a metal phosphate;
b. 15-60 wt. % of a metal oxide;
c. 2-20 wt. % of tricalcium phosphate.

2. A refractory as described in claim 1, wherein the metal phosphate is an alkali metal or alkali metal earth metal phosphate.

3. The refractory as recited in claim 1 further comprising a component selected from the group consisting of calcium silicate and silicon dioxide.

4. The refractory as recited in claim 1 further comprising calcium silicate, wherein the calcium silicate is present at between 0.5-15 wt. % of the refractory composition.

5. The refractory as recited in claim 1 further comprising silicon dioxide, wherein the silicon dioxide is present at between 0.5-15 wt. % of the refractory composition.

6. The refractory as recited in claim 1 wherein the refractory is preferably between 40 and 65 wt. % metal phosphate.

7. The refractory as recited in claim 1 wherein the refractory is preferably between 25 and 50 wt. % metal oxide.

8. The refractory as recited in claim 1 wherein the refractory is preferably between 4 and 15 wt. % tricalcium phosphate.

9. The refractory as recited in claim 1 wherein the wt. % ratio between metal phosphate and metal oxide is between 2:0.5 and 1:1.

10. The refractory as recited in claim 1 wherein the refractory composition is mixed with up to 20 wt. % water to form an activated slurry.

11. The refractory as recited in claim 1 further comprising a setting retarder.

12. A refractory comprising:
a. 20-80 wt. % of a potassium phosphate;
b. 15-60 wt. % of a MgO;
c. 2-20 wt. % of tricalcium phosphate.

13. The refractory as recited in claim 1 wherein the refractory is preferably between 40 and 65 wt. % potassium phosphate.

14. The refractory as recited in claim 1 wherein the refractory is preferably between 25 and 50 wt. % MgO.

15. The refractory as recited in claim 1 wherein the refractory is preferably between 4 and 15 wt. % tricalcium phosphate.

16. The refractory as recited in claim 1 wherein the refractory composition is mixed with up to 20 wt. % water to form an activated slurry.

17. The refractory as described in claim 1, wherein the metal phosphate is mono potassium phosphate.

18. A refractory comprising:
a. 20-80 wt. % of a metal phosphate;
b. 15-60 wt. % of a metal hydroxide
c. 2-20 wt. % of tricalcium phosphate.

19. The refractory as described in claim 18, wherein the metal phosphate is mono potassium phosphate.

20. The refractory as describe in claim 18, wherein the metal hydroxide is selected from a group consisting of: Al(OH)₃ and Zr(OH)₄.
